(19) United States
(12) Patent Application Publication
(10) Pub. No.: US 2004/0092029 A1
(43) Pub. Date: May 13, 2004

(54) Method of preparing a silicon sample for analysis

(76) Inventors: Mark L. Jones, Portland, OR (US); Hongmei Liu, Beaverton, OR (US); James J. Shen, Portland, OR (US)

Correspondence Address: KOLISCH HARTWELL, P.C., 520 S.W. YAMHILL STREET, SUITE 200, PORTLAND, OR, 97204, US

(21) Appl. No.: 10/679,992

(22) Filed: Oct. 6, 2003

Related U.S. Application Data
(60) Provisional application No. 60/417,744, filed on Oct. 9, 2002.

(51) Int. Cl. G01N 1/00

(52) U.S. Cl. 436/174

(57) ABSTRACT

A method of preparing a sample of silicon for chemical analysis is provided, wherein the method is performed in a reaction system including an outer container and an inner container. The method includes adding a volume of deionized water to the inner container, adding the sample of silicon to the inner container, adding a volume an acid to the outer container, at least partially sealing the outer container, and applying heat to the reaction system by illuminating the reaction system with a lamp.

### CROSS-REFERENCE TO RELATED APPLICATION

The application is based upon and claims the benefit under 35 U.S.C. § 119 of U.S. provisional patent application Serial No. 60/417,744, filed Oct. 9, 2002, which is hereby incorporated by reference.

### TECHNICAL FIELD

The present invention relates to a method of preparing a sample of silicon for analysis. More particularly, the method provides a method of digesting and recovering impurities from a silicon sample that allows for improved detection limits.

### BACKGROUND OF THE INVENTION

The presence of even very low levels of impurities, such as copper, nickel and other metals, in a silicon wafer can degrade the electrical characteristics of the wafer. Thus, it is important to be able to determine the concentrations of these impurities in the bulk regions of wafers before the wafers are used to make devices to ensure the electrical characteristics of the wafer match those required by the device specifications.

Impurity levels in wafers are typically determined via several different techniques. For example, dry techniques, such as Dynamic Secondary Ion Mass Spectrometry (Dynamic SIMS), may be used for some types of analyses. However, the detection limits of these methods, typically on the order of 10¹⁴-10¹⁵ atoms/cm³ for copper and nickel, may not be low enough for accurate process monitoring and quality control for high-purity wafers.

Various wet-chemical methods may also be used to measure bulk metal concentrations in wafers. For example, some wet-chemical methods involve driving impurities from the wafer bulk to a surface layer via the use of either heat or a surface pblysilicon gettering layer, and then collecting the surface impurity layer for analysis. These techniques typically have a large number of process variables that can affect the accuracy of the analytical results, such as the types and/or concentrations of dopants used in a wafer, the characteristics of the wafer backside (for example, the amount of damage present on the backside, the presence of a polysilicon layer on the backside, etc.) and the characteristics of the wafer frontside (epitaxial, polished, etc.).

Other wet-chemical methods involve digesting a small sample of silicon in a concentrated nitric acid and hydrofluoric acid solution, and then evaporating the solution to recover impurities for analysis. Several different methods may be used for digesting the sample, including hotplate methods and microwave methods.

The detection limits that may be achieved with the digestion methods are typically lower than those achieved via other methods. However, known digestion methods usually also suffer some drawbacks. For example, some methods may cause the formation of significant amounts of undesirable, silicon-containing solid residues. This may make the sample difficult to analyze without significant dilution, which may lead to loss of sensitivity. Furthermore, in some digestion methods, the samples may be susceptible to airborne contamination during the drying phase, as the digestion container may be uncovered during this process phase. Also, the acids used to digest the sample, even if of an ultra-pure grade, may still have significant enough concentrations of impurities to interfere with obtaining accurate analytical results.

### SUMMARY

A method of preparing a sample of silicon for chemical analysis is provided, wherein the method is performed in a reaction system including an outer container and an inner container. The method includes adding a volume of deionized water to the inner container, adding the sample of silicon to the inner container, adding a volume an acid to the outer container, at least partially sealing the outer container, and applying heat to the reaction system by illuminating the reaction system with a lamp.

### BRIEF DESCRIPTION OF THE DRAWINGS

FIG. 1 is a flow diagram of a method of preparing a silicon sample for analysis according to a first embodiment of the present invention.

FIG. 2 is a perspective view of a reaction container suitable for use with the embodiment of FIG. 1.

FIG. 3 is a perspective view of the reaction system of FIG. 2 placed under a lamp, with a mask in place on the lid of the reaction system.

FIG. 4 is a perspective view of the reaction system of FIG. 2 placed under a lamp, with the mask removed.

### DETAILED DESCRIPTION OF THE DEPICTED EMBODIMENTS

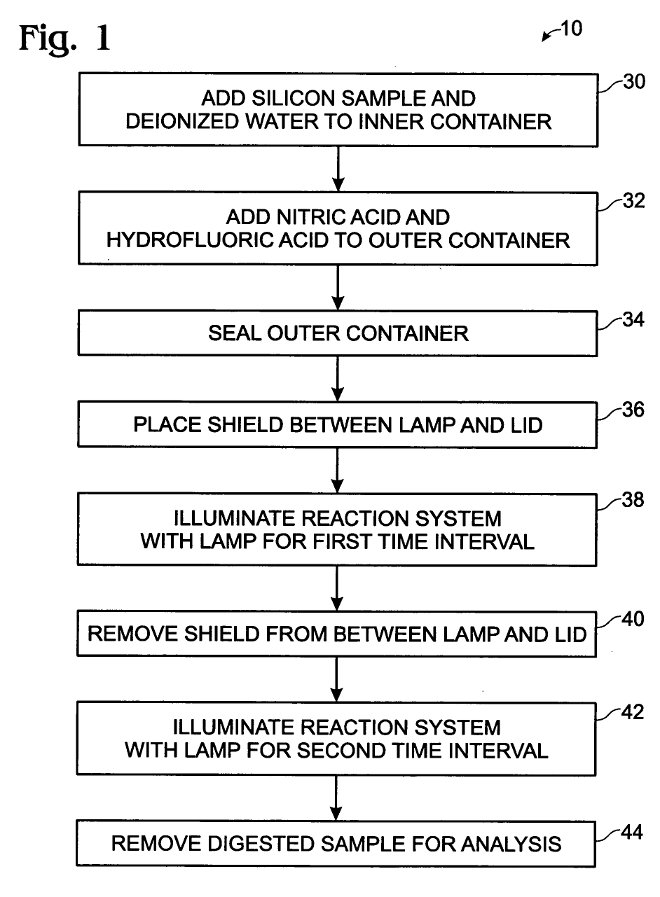

FIG. 1 shows, generally at 10, a first embodiment of a method of preparing a sample of silicon for analysis. Method 10 is configured to be performed in a reaction system, shown generally at 12 in FIG. 2, that includes an outer container 14, an inner container 16 configured to fit within the outer container and to hold a silicon sample 17, and a lid 18 or other cover configured to cover and at least partially seal the outer container. Reaction system 12 may also include a stand 20 on which inner container 16 may be set to raise the inner container above the bottom of outer container 14. Furthermore, the reaction system may include a mask 22 that may be removably attached to the lid to selectively block light from reaching inner container 16. Each of these components is described in more detail below.

Method 10 includes adding the silicon sample and a volume of deionized water to the inner container at 30, and adding nitric acid and hydrofluoric acid to the outer container at 32. Next, the outer container is sealed with the lid at 34, and the mask may be placed at a location between the lamp and lid at 36 to prevent light from reaching the inner container from above. The outer container may be only partially sealed with lid 34 so that excess gases may escape the container. Alternatively, the outer container may include a pressure regulation system, in which case lid 34 may be completely sealed. Once the mask is in place, the reaction system is illuminated, preferably from above, with a lamp at 38 to increase the vapor pressure of the acids and cause acid vapor to dissolve into the deionized water. After illuminating the reaction system for a first time interval, during which the silicon sample is digested, the mask is removed from between the lamp and the lid at 40, and the reaction system is illuminated for a second time interval at 42 to dry the sample solution. Finally, at the end of the second time interval, the inner container is removed from the reaction system, and solid residues are recovered for analysis at 44. It will be appreciated that these steps may be performed in any suitable order other than that shown in FIG. 1 and described above.

Prior methods of digesting a silicon sample in a nitric acid and hydrofluoric acid mixture typically involve adding the silicon sample directly to at least one of the acids. However, as described above, even acids of a very high purity may have sufficient concentrations of contaminants to interfere with the analysis of a high-purity silicon sample. In contrast, the acids of the present invention are introduced into the inner container by a sub-boiling distillation of the nitric acid and hydrofluoric acid from the outer container into the inner container. Because the acids are dissolved into the water from the vapor phase, the quantity of contaminants transferred from the acids into the deionized water may be lessened compared to mixing liquid acid solutions directly into the deionized water.

The vapor-phase introduction of both acids to the outer container also allows the acids to be introduced into the deionized water in a slow, controlled manner. This is advantageous, as it allows gas phase SiF₄ to be formed preferentially over the aqueous solid H₂SiF₆. When silicon is digested into a mixture of hydrofluoric acid and nitric acid, two major competing reactions may take place. These are:

Si(s)+4HNO₃(aq)+6HF→H₂SiF₆(aq)+4NO₂(g)+4H₂O(l) (1)

3Si(s)+4HNO₃(aq)+12HF→3SiF₄(g)+4NO(g)+8H₂O(g) (2)

Where excesses of HF and HNO₃ are available, reaction (1) is favored. This causes the production of H₂SiF₆, which forms undesirable silicon-containing solid residues that interfere with quantitative analysis when dried. On the other hand, where HF and HNO₃ are introduced into the deionized water in limited quantities, reaction (2) is favored. In this reaction, silicon is eliminated from the reaction container in the form of gaseous SiF₄. Therefore, by limiting the amounts of both acids that are in the inner vessel by sub-boiling distillation, reaction (2) will be preferred, and the presence of unfavorable silicon-containing solids in the analytical sample may be reduced.

Outer container 14, inner container 16, lid 18 and stand 20 may be formed from any suitable material or materials. Suitable materials include those that are inert to hydrofluoric and nitric acids, are of a high purity, have relatively low levels of metallic concentrations, and/or are translucent or transparent to allow the solutions to be heated by lamp, as described in more detail below. Suitable materials include, but are not limited to, high-purity perfluoroalkoxy (PFA) plastic.

The deionized water added to the inner container may have any suitable purity. To help lessen the introduction of outside contaminants into the sample mixture, the deionized water may have an extremely high purity, for example, as measured by a resistivity of 18 megaohm-meters.

Any suitable hydrofluoric acid and nitric acid solutions may be added to outer container 14. One example of a suitable hydrofluoric acid solution is a 49% ultra-pure, laboratory grade HF solution, such as ULTREX II from JT Baker. Likewise, one example of a suitable nitric acid solution is a 68% ultra-pure, laboratory grade HNO₃ solution, such as ULTREX II from JT Baker. Alternatively, lower purity acids may also be used, as the sub-boiling distillation of acids from outer container 14 into inner container 16 may purify the acids sufficiently to avoid introducing additional contaminants into the analytical sample.

The hydrofluoric acid and nitric acid solutions may be added to outer container 14 in any suitable ratio. Suitable ratios include, but are not limited to, those between 1:20 and 20:1. In one embodiment, the nitric acid and hydrofluoric acid solutions are added in a 3:4 volumetric ratio. While FIG. 1 depicts adding the silicon sample and deionized water to the inner container before adding the acids to the outer container, it will be understood that these steps may be performed in any other desired order.

The volume of acids and deionized water added to the outer container and inner container, respectively, are typically selected based at least partially upon the sizes of outer container 14, inner container 16, and sample 17. For example, where outer container 14 has a volume of three hundred mL, inner container 16 has a volume of fifteen mL, and sample 17 has a mass of approximately one gram, approximately thirty mL of nitric acid and approximately forty mL of hydrofluoric acid may be added to the outer container, and approximately 9.5 mL of deionized water may be added to the inner container. It will be appreciated that the above fluid volumes are merely exemplary, and any other suitable volumes and/or ratios of fluids may be used. Suitable volumes of deionized water include, but are not limited to, those that cover the sample. Likewise, it will be appreciated that the above container sizes are merely exemplary, and that the containers may have any other suitable sizes. However, the use of larger containers, and especially a larger and/or taller inner container, may slow down the sample drying portion of sample preparation method 10, and thus increase the overall sample preparation time.

After adding the sample, deionized water and acids to reaction system 12, lid 18 is placed over outer container 14. The use of lid 18 helps to prevent atmospheric contaminants from contaminating the deionized water. Lid 18 also helps to retain the nitric acid and hydrofluoric acid vapors within reaction system 12.

As sample 17 reacts with the hydrofluoric and nitric acids, gaseous SiF₄ is produced. To allow excess gases to escape reaction system 12, lid 18 may be attached somewhat loosely to outer container 14. For example, where lid 18 is configured to be screwed onto outer container 14, the lid may be screwed only partially on so that excess vapor can escape through the small gap between the lid and the outer container. Alternatively, the lid may be attached tightly, and periodically loosened to allow excess gases to escape.

Other mechanisms may also be used to control the pressure within reaction system 12. For example, an exhaust port may be formed in the side of outer container 14 to allow excess gases to escape. The flow of gas through the exhaust port may be regulated to control the pressure within outer container 14 more accurately. One suitable method of controlling the flow of gas through the exhaust port may be to couple a check valve to the exit of the exhaust port. The check valve may be configured to open and release gas when pressure within outer container 14 exceeds a predetermined threshold. Alternatively, the exhaust port outlet may be connected to a bubbler via a hose or other conduit, wherein a predetermined amount of pressure is needed to expel gas bubbles through the bubbler.

The use of an exhaust port coupled to a pressure regulator offers the advantage that the pressure within reaction system 12 may be more closely regulated than where lid 18 is left only partially sealed. Regulation of pressure within reaction system 12 may help to improve the precision of the digestion process, and may allow recoveries of impurity metals to be performed with a high degree of reproducibility, as evidenced in the experimental results described herein.

Where a pressure regulator is used, the regulator may be configured to hold the pressure within outer container 14 at, below or above any suitable level or threshold. Examples of suitable pressures include, but are not limited to, those in the range of 750-770 mm Hg, and more typically between 758-762 mm Hg.

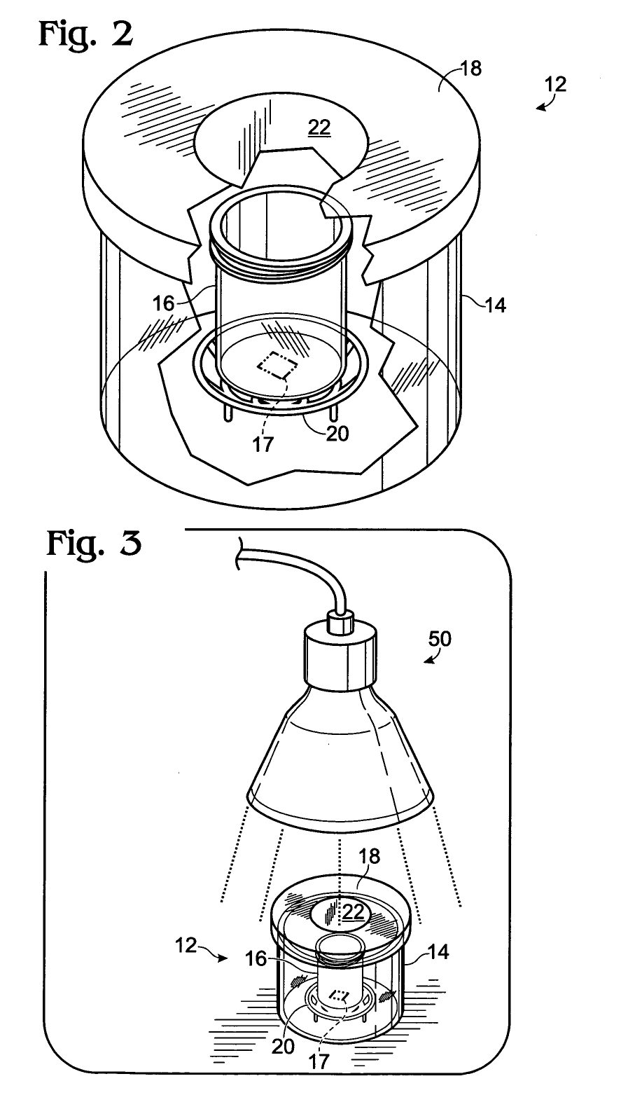

After attaching lid 18 to outer container 14, heat may be applied to reaction system 12 to increase the vapor pressure of the hydrofluoric and nitric acids within the reaction system, and thus to increase the rate of dissolution of the acids into the deionized water. Heat may be applied to reaction system in any suitable manner. In some embodiments, heat is applied to reaction system 12 via a lamp directed at lid 18. An example of a suitable lamp is depicted generally at 50 in FIG. 3. The use of a lamp to heat reaction system 12 offers several potential advantages over the use of other heat sources. For example, heating reaction system 12 from above with lamp 50 may help to prevent condensation from forming on lid 18, and thus may help to prevent contaminants leached from the lid by the acids from dripping into inner container 16. Applying heat from above also may heat the upper walls of inner container 16 more than the lower walls of the inner container, and thus may help to prevent the solution within inner container 16 from refluxing.

Any suitable type of lamp may be used to heat the contents of reaction system 12. For example, either a full-spectrum lamp, such as a xenon arc-lamp, or a line-source, such as a mercury vapor lamp, may be used as lamp 50, depending upon the optical properties of the components of reaction system 12 and the fluids contained within the reaction system. Likewise, a less-expensive, ordinary incandescent lamp may be used if desired. An example of a suitable incandescent source is 120V, 120W incandescent spot bulb.

Lid 18 may be heated to any desired temperature. For example, with the exemplary dimensions set forth above, lid 18 may be heated to a temperature between approximately twenty-five and one hundred twenty degrees Celsuis, and more typically between fifty and ninety degrees Celsius, for the sample digestion phase of process 10. Alternatively, lid 18 may be heated to higher temperatures, such as approximately two hundred degrees Celsius. Where higher temperatures are used, a larger volume of deionized water may be used to compensate for higher evaporation rates and different reaction dynamics. It will be appreciated that the temperatures specified herein are merely exemplary, and that the system may be heated to any other suitable temperature. Furthermore, it will be appreciated that the temperature may be changed during the sample digestion phase, or may be held constant.

The temperature of lid 18 may be controlled in any suitable manner. For example, the temperature may be controlled by simply adjusting the distance of the lamp from the lid. Where additional control over the digestion reaction is desired, the temperature of the reaction system may be controlled via a feedback mechanism. For example, a thermocouple may be attached to lid 18 to monitor the temperature of the lid. The output from the thermocouple may be provided to a PID (Proportional-Integral-Derivative) controller that is used to control power to the lamp. In this manner, power to the lamp may be appropriately switched on and off to keep lid 18 close to a selected temperature.

Alternatively, the feedback control thermocouple may be coupled to the bottom of outer container 16, or to another location that is in close thermal communication with the temperature of the acids in the bottom of the outer container. Monitoring the temperature of the acid solution rather than the lid may allow the rate of evaporation of the acid solution to be more closely controlled, and thus to allow digestions to be performed in a highly reproducible manner. The acid solution may be heated to any suitable temperature. Suitable temperatures include, but are not limited to, those in the range of between twenty and eighty degrees Celsius, and more typically between forty-five and sixty degrees Celsius. In one embodiment, the temperature of the acid solution is held between fifty-one and fifty-three degrees Celsius.

Additional heat may be provided to the bottom of outer container 14 by the use of a hotplate or like heat source. Heating the bottom of outer container 14 simultaneously with heating the top of the container with the lamp may allow greater control of the temperature of the acid solution within outer container 14, and thus greater control over the evaporation of the acids and the introduction of the acids into the deionized water. This may, in turn, allow greater control of the digestion of the silicon sample, and thus may lead to more reproducible recoveries and analyses.

During the digestion phase of process 10, it may be desirable to limit the evaporation of solution from inner container 16 so that the solubility of the sample in the solution remains high throughout the digestion phase of the sample preparation process. Thus, as described above, mask 22 may be attached to lid 18 during the first time interval to help prevent excess evaporation of solution from inner container 16 during the digestion process.

Mask 22 may be positioned on lid 18 in any suitable location. Suitable locations include those that shade inner container 16 from direct illumination by lamp 50. Thus, where lamp 50 is positioned directly above lid 18, mask 22 may be placed on the center of lid 18. Likewise, where lamp 50 is not positioned directly above lid 18, mask 22 may be offset appropriately.

Also, mask 22 may be made from any suitable material. Suitable materials include those that either absorb or reflect substantially all incident light. A material that absorbs incident light may be preferable in some instances, as such a material may help to heat lid 18 and prevent condensation from forming on lid 18. One example of a very simple mask 22 is an appropriately sized and shaped piece of black, blue or other color electrical tape. Alternatively, mask 22 may be made of a plastic material, such as a pigmented PFA plastic. Other suitable materials include, but are not limited to, metals, ceramics and other plastics. While mask 22 is depicted as being positioned directly on the upper surface of lid 18, it will be appreciated that a suitable mask may be placed at any other desired location between lamp 50 and inner container 16. For example, an opaque or reflective mask may be held in a position intermediate lamp 50 and lid 18 with a suitable stand. It will be appreciated that mask 22 may also be omitted if desired. Where mask 22 is omitted, it may be desirable to increase the volume of deionized water added to inner container 16 to compensate for a potentially higher rate of evaporation of solution from inner container 16.

Reaction system 12 may be illuminated with mask 22 in place for any desired length of time. Typically, reaction system 12 is illuminated with mask 22 in place for the duration of the digestion phase of sample preparation process 10. For the exemplary reaction conditions given above, reaction system 12 is typically heated with mask 22 in place for twelve to eighteen hours. Times within this range are typically sufficient to allow the digestion reaction to proceed to completion.

Once digestion of sample 17 is complete, mask 22 may be removed from lid 18, as shown in FIG. 4. Next, reaction system 12 may be illuminated for a second time interval without mask 22 to dry the solution within inner container 16. Reaction system 12 may be heated to any suitable temperature for this phase of sample preparation process 10. For a reaction system with the exemplary dimensions given above, the system may be so that lid 18 has a temperature of between about forty and about one hundred ten degrees Celsius, and more typically between about forty and about fifty degrees Celsius. In one embodiment, lid 18 is heated to approximately eighty degrees for the drying phase of method 10. Reaction system 12 is typically heated in this phase until the interior of inner container 16 is completely dry inside. The duration of the drying process may depend upon the volume of solution contained within inner container 16 before the drying process is begun. For the exemplary reaction conditions and fluid volumes described above, times of eight to twelve hours, and more typically approximately ten hours, are generally sufficient to dry the solution within inner container 16 completely. Alternative, longer drying times, up to three days or even longer, may be used to ensure sample dryness. It will be appreciated that the digestion and drying phases may be performed at the same temperature if desired.

After the solution within inner container 16 has been completely dried, inner container 16 may be removed from outer container 14, and impurities from the digested sample 17 may be recovered from the inner container. The impurities are recovered by re-dissolving them in a known volume of solution. Any suitable solution may be used to recover the impurities. Suitable solutions include those in which the impurities are soluble, and which do not interfere excessively with the method of quantitative analysis selected to analyze the sample. Examples of suitable solutions include, but are not limited to, solutions containing approximately 5% hydrofluoric acid and approximately 12% hydrogen peroxide. For the exemplary reaction system described above, a 250 microliter volume of a 5% hydrofluoric acid/12% hydrogen peroxide solution may be added to inner container 16 and shaken around the bottom of the inner container to recover contaminants from the digested sample. The reconstitution solution containing the recovered contaminants may then be analyzed by any suitable method, including but not limited to, inductively coupled plasma mass spectroscopy (ICPMS) or graphite furnace atomic absorption spectroscopy (GFAAS). Typically less than 0.001 grams of solids remain in inner container 16 after drying. This allows a smaller volume of reconstitution solution, on the order of 250 microliter, to be used to recover the solids. This may help to avoid the need to dilute the solution excessively, and thus may help to improve the detection limit of the sample analysis.

### Experimental Results

Experimental results confirm that a silicon sample prepared for analysis in accordance with the above-described methods has a smaller quantity of undesirable silicon-containing solids than samples prepared by prior methods. All experiments summarized below were performed via the following steps. First, 1 g of silicon is placed into the inner container, and then 9.5 mL of deionized water are added to the inner container. Next, 30 mL of 68% nitric acid and 40 mL of 49% hydrofluoric acid are added to the outer container. After adding the deionized water, acids and sample to the reaction system, the lid is screwed partially on, and the reaction system is placed directly under the spot lamp. The height of the lamp is adjusted until the top of the reaction system equilibrates at approximately 50 degrees Celsius. The lid typically equilibrates within 15-20 minutes of changing the lamp height. Next, the mask is placed on the lid, and the digestion reaction is allowed to proceed for 16 hours.

After the digestion reaction is complete, the mask is removed, and the reaction system is heated for an additional 10 hours to dry the inside of the inner container. Once dry, the inner container is removed, and solid residues are removed with 250 microliters of a 0.5% HF/12% H₂O₂ solution to form a reconstitution solution. The reconstitution solution is analyzed by ICPMS using a hot plasma with a masked torch.

Table 1 shows a comparison of the mass of residual solids produced by four different digestion methods. Of the four digestion methods, by far the smallest amount of 5 residual solids was produced by the new methods disclosed herein.

TABLE I

| Digestion method | | | | | |
|---|---|---|---|---|---|
| for 1 g Si | Reaction time | | Evaporation time | | Grams residue |
| Open, single | 0.5 | hr | 2 | hrs on hotplate | 0.12 |
| container, Si | | | | | |
| added to | | | | | |
| concentrated | | | | | |
| HF/HNO₃ | | | | | |
| Open container, | 2 | hrs | 2 | hrs on hotplate | 0.06 |
| HF added | | | | | |
| gradually to | | | | | |
| HNO₃ | | | | | |
| and Si | | | | | |
| Semi-closed | 8 | hrs | 20 | min on hotplate | 0.008 |
| vessel, 8 mL | | | | | |
| HNO₃, Si inner | | | | | |
| vessel/ | | | | | |
| 40 mL HF outer | | | | | |
| vessel | | | | | |
| Semi-closed | 16 | hrs | 10 | hrs under lamp | <0.001 |
| vessel, 9.5 mL | | | | | |
| deionized water, | | | | | |
| Si inner vessel/ | | | | | |
| 40 mL HF and 30 | | | | | |
| mL HNO3 outer | | | | | |
| vessel | | | | | |

Next, a series of acid blanks were analyzed. The blanks were prepared by performing the method detailed above without the addition of a silicon sample to the inner container. The blanks initially showed detectable concentrations of nickel and copper. However, the levels of these contaminants dropped to undetectable levels after only a few trials. The initial elevated levels were attributed to the inner vessels being new.

After analysis of the acid blanks, a series of samples with known amounts of nickel and copper were analyzed to determine whether any quantities of copper and/or nickel were lost during the sample preparation process. Table II shows the results of these experiments.

TABLE II

| | Known [Cu] | Detected [Cu] | Known [Ni] | Detected [Ni] |
|---|---|---|---|---|
| Sample | (ppt) | (ppt) | (ppt) | (ppt) |
| 1 | None | <DL | None | 14.66 |
| 2 | None | <DL | None | <DL |
| 3 | 40 | 41.01 | 40 | 64.77 |
| 4 | 40 | 44.53 | 40 | 48.34 |
| 5 | 400 | 430.0 | 400 | 469.9 |
| 6 | 400 | 407.8 | 400 | 439.6 |

This data shows excellent recoveries for Cu at both known levels. Recoveries for Ni were also good, although less consistent at the lower concentration.

Next, actual samples of Si cleaved from a wafer were digested and prepared via the process described above. Known amounts of copper and nickel were added to some of the samples, while others were left unaltered. Table III shows results from these experiments.

TABLE III

| | [Cu], | | [Cu] | | | | [Ni] | | |
|---|---|---|---|---|---|---|---|---|---|
| Sample | [Ni] | [Cu] | (pg/g | [Cu] | [Cu] | [Ni] | (pg/g | [Ni] | [Ni] |
| No. | added | (ppt) | Si) | (at/cm²) | (at/cm³) | (ppt) | Si) | (at/cm²) | (at/cm³) |
| 1 | 0 | 529 | 126.01 | 2.09e¹¹ | 2.78e¹² | 548 | 130.54 | 2.35e¹¹ | 3.12e¹² |
| 2 | 0 | 596 | 140.21 | 2.33e¹¹ | 3.1e¹² | 582 | 136.92 | 2.46e¹¹ | 3.27e¹² |
| 3 | 0 | 717 | 168.99 | 2.81e¹¹ | 3.73e¹² | 620 | 146.13 | 2.63e¹¹ | 3.49e¹² |
| 4 | 250 pg | 1448 | 359.06 | 5.97e¹¹ | 7.93e¹² | 1268 | 314.42 | 5.66e¹¹ | 7.51e¹² |
| 5 | 250 pg | 868 | 211.71 | 3.52e¹¹ | 4.67e¹² | 1211 | 295.37 | 5.32e¹¹ | 7.06e¹² |
| 6 | 250 pg | 1744 | 411.63 | 6.84e¹¹ | 9.09e¹² | 1324 | 312.50 | 5.62e¹¹ | 7.47e¹² |

The experimental results summarized in Table III show good recoveries for both elements. The recoveries related to the added Cu and Ni are not as good as for the solutions without Si (Table II). However, this is to be expected with samples obtained from actual wafers, as there may be actual differences in the amount of Cu and Ni in different parts of the same wafer.

To determine the reproducibility and the accuracy of recovery of metals from the above-described digestion methods, a spike recovery test was performed. Four pieces of a single wafer were cleaved and weighed before being inserted into four separate reaction systems (one for each piece). 9.5 mL of deionized water was added to each reaction system. Next, 0.1 nanograms of each of copper, nickel and chromium were added to the inner containers of two of the four reaction systems. Each sample was digested according to the above-described methods, with the lid of the reaction system held at eighty degrees Celsuis for the duration of the digestion, except that the pressure within the outer container was held at approximately 760 mm Hg by the use of an outer container with an exhaust port that exhausts waste gases through a bubbler. After digestion, the samples were dried at a temperature of eighty degrees Celsius for approximately three days. Percentage recoveries were calculated using the two unspiked samples to determine the baseline amount of each of these metals in the wafer bulk. The results are shown in Table IV below.

TABLE IV

| | [Cu] | [Ni] | [Cr] |
|---|---|---|---|
| Sample No. | (ng/g Si) | (ng/g SI) | (ng/g Si) |
| Piece 1 | 0.033746 | 0.097409 | 0.012964 |
| Piece 2 | 0.020368 | 0.071069 | 0.011949 |
| Average of | 0.027057 | 0.084239 | 0.012456 |
| samples 1 and 2 | | | |
| Average of | 0.127057 | 0.184239 | 0.112456 |
| samples 1 and 2 | | | |
| plus 0.1 ng spike | | | |
| of Cu, Ni and Cr | | | |
| Piece 3 + 0.1 ng | 0.088429 | 0.155273 | 0.07847 |
| spike | | | |
| Piece 4 + 0.1 ng | 0.091772 | 0.175147 | 0.087113 |
| spike | | | |
| Piece 3 | 69.59763 | 84.27809 | 69.77862 |
| % recovery | | | |
| Piece 4 | 72.22917 | 95.06527 | 77.46348 |
| % recovery | | | |
| Average recovery | 70.9134 | 89.67168 | 73.62105 |

The precision of the above-described digestion and recovery methods was also studied. In this study, seven samples were taken from each of two different wafers, for a total of fourteen samples. Next, a strip extending across the wafer from edge to edge was cleaved from the wafer and divided into small pieces. Seven pieces were then selected randomly from the larger group of pieces. Each of the pieces were digested and dried under the same conditions as described above for the experiment summarized in Table IV. The recoveries from the first wafer (p/p+ type wafer) are summarized below in Table V, and the recoveries from the second wafer (p+) are summarized in Table VI.

TABLE V

| [Cu] (atoms/cm³) | [Ni] (atoms/cm³) | [Cr] (atoms/cm³) |
|---|---|---|
| 3.48e¹² | 3.57e¹³ | 5.23e¹¹ |
| 2.69e¹² | 3.85e¹³ | 5.63e¹¹ |
| 3.65e¹² | 3.59e¹³ | 4.48e¹¹ |
| 2.46e¹² | 3.62e¹³ | 5.87e¹¹ |
| 2.53e¹² | 3.64e¹³ | 5.07e¹¹ |
| 2.76e¹² | 3.42e¹³ | 1.17e¹² |
| 3.75e¹² | 3.81e¹³ | 1.35e¹² |

TABLE VI

| [Cu] (atoms/cm³) | [Ni] (atoms/cm³) | [Cr] (atoms/cm³) |
|---|---|---|
| 1.37e¹⁴ | 4.95e¹² | 2.46e¹² |
| 1.31e¹⁴ | 5.53e¹² | 2.69e¹² |
| 1.27e¹⁴ | 7.14e¹² | 5.02e¹² |
| 1.31e¹⁴ | 8.16e¹² | 4.20e¹² |
| 1.29e¹⁴ | 5.48e¹² | 2.79e¹² |
| 1.34e¹⁴ | 4.96e¹² | 1.75e¹² |
| 1.28e¹⁴ | 6.10e¹² | 2.32e¹² |

The results shown in Tables IV-VI show that the methods and system described herein provide both for good percent recoveries and precision, even with very low concentrations of metal contaminants.

Although the experimental results above pertain to the determination of copper, nickel and chromium impurities, it will be appreciated that the methods disclosed herein may also be used to prepare samples for the analyses of other materials, including but not limited to lithium, titanium, cobalt and iron. Furthermore, although the present invention has been disclosed in specific embodiments thereof, the specific embodiments are not to be considered in a limiting sense, because numerous variations are possible. The subject matter of the invention includes all novel and nonobvious combinations and subcombinations of the various elements, features, functions, and/or properties disclosed herein. Claims may be presented in a later related application that particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through later amendments or through presentation of new claims in a related application. Such claims, whether broader, narrower, equal, or different in scope to the original claims, also are regarded as included within the subject matter of the invention of the present disclosure.

What is claimed is:

1. A method of preparing a sample of silicon for chemical analysis, wherein the method is performed in a reaction system that includes an outer container and an inner container disposed within the outer container, the method comprising:
adding a volume of a solvent to the inner container;
adding the sample of silicon to the inner container;
adding a volume of hydrofluoric acid to the outer container;
adding a volume of nitric acid to the outer container; and
applying heat to the reaction system to vaporize at least some of the hydrofluoric acid and nitric acid and to dissolve at least some of the vaporized hydrofluoric acid and nitric acid into the solvent.

2. The method of claim 1, wherein the solvent is deionized water.

3. The method of claim 1, wherein the reaction system includes a lid, and wherein applying heat to the reaction system includes applying heat to the lid of the reaction system.

4. The method of claim 1, wherein heat is applied to the reaction system with a lamp.

5. The method of claim 4, wherein the lamp is an incandescent lamp.

6. The method of claim 1, wherein applying heat to the reaction system includes heating the lid of the reaction system to a temperature of less than or equal to approximately 120 degrees Celsius.

7. The method of claim 6, wherein heating the lid of the reaction system to a temperature of less than or equal to approximately 120 degrees Celsius includes heating the lid of the reaction system to a temperature of less than or equal to 120 degrees Celsius to digest the silicon sample, and further comprising drying the digested silicon sample after digesting the silicon sample by heating the lid of the reaction system to a temperature of between approximately 40 and 110 degrees Celsius.

8. The method of claim 1, wherein applying heat to the reaction system includes heating the acid in the outer container to a temperature of between approximately 20-80 degrees Celsius.

9. The method of claim 1, wherein the nitric acid and hydrofluoric acid are purified by sub-boiling distillation before being dissolved into the solvent.

10. The method of claim 1, wherein the reaction system includes a lid, and further comprising at least partially sealing the lid before applying heat to the reaction system.

11. The method of claim 10, further comprising completely sealing the lid before applying heat to the reaction system.

12. The method of claim 1, wherein the inner container is disposed on a stand contained within the outer container.

13. The method of claim 1, wherein the inner container and outer container are made of perfluoroalkoxy (PFA) plastic.

14. The method of claim 1, wherein the reaction system includes a lid and heat is applied to the reaction with a lamp, and further comprising partially covering the lid with a mask while applying heat to the reaction system.

15. The method of claim 14, further comprising removing the mask after applying heat for a first time interval, and then removing the mask and applying heat for a second time interval to dry the sample.

16. The method of claim 15, wherein the lid is heated to approximately the same temperature for the first time interval and the second time interval.

17. The method of claim 15, wherein the mask shields the inner container from direct illumination by the light emitted by the lamp.

18. The method of claim 1, wherein applying heat to the reaction system includes simultaneously applying heat to the lid of the reaction system and to a bottom surface of the outer container.

19. The method of claim 18, wherein heat is applied to the bottom surface of the outer container with a hot plate.

20. The method of claim 1, further comprising regulating the pressure within the outer container while applying heat to the reaction system.

21. The method of claim 20, wherein regulating the pressure within the outer container includes regulating the pressure via a check valve coupled to an outlet formed in the outer container.

22. The method of claim 20, wherein regulating the pressure includes maintaining the pressure in a range between 750 mm Hg and 770 mm Hg.

23. A method of preparing a sample of silicon for chemical analysis, wherein the method is performed in a reaction system including an outer container, an inner container, and a lid for at least partially sealing the outer container, the method comprising:
adding the sample of silicon to the inner container;
adding a volume of deionized water to the inner container;
adding a volume of hydrofluoric acid to the reaction system;
adding a volume of nitric acid to the reaction system;
at least partially sealing the outer container with a lid; and
applying heat to the lid of the reaction system.

24. The method of claim 23, wherein the volume of hydrofluoric acid is added to the outer container, and wherein applying heat to the lid of the reaction system vaporizes at least some of the hydrofluoric acid to dissolve at least some of the hydrofluoric acid into the deionized water.

25. The method of claim 23, wherein the volume of nitric acid is added to the outer container, and wherein applying heat to the lid of the reaction system vaporizes at least some of the nitric acid to dissolve at least some of the nitric acid into the deionized water.

26. The method of claim 23, wherein applying heat to the lid includes applying heat to the lid with a lamp.

27. The method of claim 23, wherein applying heat to the lid includes applying a mask to the lid and heating the reaction system for a first period of time, and then removing the mask and applying heat for a second period of time.

28. The method of claim 23, further comprising applying heat to a bottom surface of the outer container at the same time heat is applied to the lid.

29. A method of preparing a sample of silicon for chemical analysis, wherein the method is performed in a reaction system including an outer container, an inner container, and a lid for at least partially sealing the outer container, the method comprising:
adding a volume of deionized water to the inner container;
adding the sample of silicon to the inner container;
adding a volume of hydrofluoric acid to the outer container;
adding a volume of nitric acid to the outer container;
at least partially sealing the outer container with the lid; and
applying heat to the reaction system by at least partially illuminating the lid of the reaction system with a lamp.

30. The method of claim 29, wherein at least partially illuminating the lid of the reaction system with a lamp includes positioning a mask between the lamp and the reaction system that at least partially masks the inner container for a first heating interval, and then removing the mask for a second heating interval.

31. A method of preparing a sample of silicon for chemical analysis, wherein the method is performed in a reaction system including an outer container and an inner container, the method comprising:
adding a volume of deionized water to the inner container;
adding the sample of silicon to the inner container;
adding a volume of an acid to the outer container;
at least partially sealing the outer container; and
applying heat to the reaction system by illuminating the reaction system with a lamp.

32. The method of claim 31, wherein adding a volume of an acid to the outer container includes adding a volume of hydrofluoric acid and a volume of nitric acid to the container.

33. The method of claim 31, the reaction system including a lid, wherein applying heat to the reaction system includes applying heat to the lid of the reaction system.

34. A system for digesting a sample of silicon for analysis, the system comprising:
an outer container configured to hold a volume of an acid solution;
an inner container configured to hold the silicon sample and a volume of a solvent in which an acid in the acid solution is soluble;
a stand configured to support the inner container above the acid solution in the outer container; and
a lid configured to at least partially seal the outer container.
